(19) United States
(12) Patent Application Publication
(10) Pub. No.: US 2009/0113471 A1
(43) Pub. Date: Apr. 30, 2009

(54) METHOD AND APPARATUS FOR SIGNALING UPDATES TO NOTIFICATION SESSION IN IP DATACAST

(75) Inventors: Imed Bouazizi, Tampere (FI); Jani Vare, Kaarina (FI)

Correspondence Address: FOLEY & LARDNER LLP, P.O. BOX 80278, SAN DIEGO, CA, 92138-0278, US

(73) Assignee: Nokia Corporation

(21) Appl. No.: 12/145,390

(22) Filed: Jun. 24, 2008

Related U.S. Application Data
(60) Provisional application No. 60/946,111, filed on Jun. 25, 2007.

(51) Int. Cl. H04N 7/10

(52) U.S. Cl. 725/32

(57) ABSTRACT

Systems and methods of signaling changes and updates associated with the default notification channels in a non-time sliced way are provided. A default notification channel event is signaled to a terminal. The signaling includes a reference to the relevant default notification channel, a timestamp, and/or a version number/counter. A comparison is made between a stored timestamp and/or version number/counter with the timestamp and/or version number/counter indicated in the signaling. A more recent timestamp and/or version number/counter prompts the terminal to tune in to the default notification channel to process the default notification channel event. The signaling can be performed using Program Specific Information/Service Information (PSI/SI), which is non-time-sliced and is received by all terminals. Additionally, the PSI/SI signaling is effectuated by creating descriptors in existing notification/network information tables and/or by creating a dedicated notification signaling table.

### FIELD OF THE INVENTION

The present invention relates generally to the field of multimedia broadcast and multicast service systems. More particularly, the present invention relates to notification channel signaling and functionality within broadcast and multicast systems.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Mobile multicast and broadcast systems have recently been standardized by different organizations, such as the 3^{rd} Generation Partnership Project (3GPP) Multimedia Broadcast/Multicast Service (MBMS), the Digital Video Broadcasting (DVB) Technical Module Convergence of Broadcast and Mobile Services (TM-CBMS), and the Open Mobile Alliance (OMA) Mobile Broadcast Services (BCAST) organizations. Other multicast and broadcast systems further include Integrated Services Digital Broadcasting—Terrestrial (ISDB-T), Digital Multimedia Broadcast-Terrestrial/Handheld (DMB-T/H), Digital Multimedia Broadcasting (T-DMB), Forward Link Only (FLO) and proprietary systems, such as for example, MediaFLO. Two primary services provided by such multicast/broadcast solutions are streaming and file delivery services. Although streaming services are considered to be the primary driver of the technology (e.g., the Mobile TV application), file delivery is expected to generate a significant amount of the traffic, as well as a significant amount of the revenues. For example, in the delivery of music and video clips, the file delivery may comprise the primary application component. Alternatively, file delivery may be a secondary component of the application, such as in the case of rich media applications and zapping streams.

In the case of file delivery, File Delivery over Unidirectional Transport (FLUTE) can be used as the file delivery protocol. FLUTE is defined by the Internet Engineering Task Force (IETF) and is based on the Asynchonous Layered Coding (ALC) Protocol Instantiation. ALC comprises a set of building blocks such as the Layered Coding Transport (LCT) block and the Forward Error Correction (FEC) building block. FLUTE extends ALC by, among others, defining mechanisms to describe the contents of the FLUTE session. This is achieved by introducing a well-known object with a Transport Object Identifier (TOI) equal to zero, carrying a File Delivery Table (FDT) instance. The FDT instance lists a set of files and their corresponding transport options. The FDT is an Extensible Markup Language (XML) file following an arrangement defined in the FLUTE specification.

Another component of multicast and broadcast services is referred to as a notification service. Notification services complement mobile TV services by offering a way to enable interactivity and delivery of service related information, while also enabling new and/or critical services, such as emergency notifications. A Tsunami notification service is an example of an emergency notification.

DVB TM-CBMS is currently defining a notification framework under the scope of a next Internet Protocol Datacast system (IPDC), IPDC 2.0, that seeks to enable the realization of several use cases, which have already been defined. These use cases are described in “IP Datacast over DVB-H: Notification (Living Document)”, TM-CBMS 1520r8. It may be noted that notification use cases can be classified according to the following criteria: whether a notification has strong or loose time constraints, e.g., a notification that should be received within a given time and/or may be processed with various timing requirements; whether a notification is directed to a terminal or to a user, e.g., a notification targeted to the terminal or an application residing thereon, or a notification targeted to the user, where the terminal's involvement in processing the notification goes beyond what is required to present the notification to the user; where a notification is service-related or service-agnostic, e.g., a notification that is reliant upon or independent of a service, respectively; and whether a notification requires interactivity or not, e.g., a notification, the main purpose of which is to lead a terminal to subsequent interaction with a network or application.

DVB-H has introduced “time-slicing” as a method of minimizing power consumption at the terminal side, where a terminal receiver is conventionally turned on for a very small fraction of time. However, this “on-time” is generally a sufficient amount of time to receive all the data of a specific service. FIG. 1 illustrates conventional time-slicing with regard to burst transmissions, where time and bandwidth are illustrated as horizontal and vertical axes, respectively. The size of an actual burst is shown at 100, where the burst has a bandwidth 110 and a duration 120. It should be noted that in broadcast and multicast systems, information can be transmitted and received periodically in bursts to reduce, for example, power consumption at the terminal receiver. The constant service bandwidth is shown at 130. Each burst can carry multi-protocol encapsulation (MPE) sections, each of which can include an MPE section header containing a delta-t value (time to the beginning of the next burst). A delta-t of the last MPE section of a burst is illustrated at 140 and the “off-time” is shown as a time between bursts, e.g., between the end of a burst and the beginning of a subsequent burst.

Certain default notification channels have been introduced that are sent in a time-sliced manner, such as that described in FIG. 1, where the FLUTE protocol is conventionally utilized. Terminals tune into the correct data burst in order to receive the notification messages. However, terminals are generally tuned to and following another service (e.g., a mobile TV channel) and it is not practical (e.g., in terms of power consumption and receiver implementation) to stay tuned to two different data bursts simultaneously. Additionally, certain signaling exists within Program Specific Information/Service Information (PSI/SI) as described in the European Telecommunications Standards Institute (ETSI) specification EN 300 468, “Specification for Service Information (SI) in DVB Systems.” However, such signaling is only utilized for emergency messaging, where the signaling can be applied to bootstrap (e.g., locate) an announcement (notification) stream. Moreover, in light of the low bitrate nature of the certain default notification messages noted above, the option of continuously tuning into a notification channel can be inefficient.

### SUMMARY

Various embodiments allow for the signaling of changes and updates associated with the default notification channels in IPDC over DVB-H in a non-time sliced way. A default notification channel event occurs, and the default notification channel event is signaled to a receiver terminal. The signaling can include, for example, a reference to the default notification channel to which the signaling relates, and a timestamp indicative of the last time the relevant default notification channel has been changed. Alternatively, a version number of a network information table (NIT) or other counter can be included in the signaling, or a combination of a timestamp and version number can be utilized to determine default notification changes. A receiver can memorize the last update time and/or the last received NIT version number/counter for each default notification channel. Upon receiving a signal indicating that a default notification channel has been updated, the receiver can compare the stored timestamp and/or version number/counter with the timestamp and/or version number/counter indicated in the signaling. If the timestamp and/or version number/counter included in the signaling is more recent, the terminal tunes in to the default notification channel to process the default notification channel event.

According to another embodiment, the signaling may also indicate a priority of the update, version number, and/or the timestamp of the last high priority notification message in the corresponding default notification session. Other fields associated with the signaling can indicate the type of the new notification message or the action that the terminal needs to perform based on the new notification message.

The signaling of the default notification channel event can be performed using PSI/SI, where the PSI/SI signaling is non-time-sliced and is received by all terminals, e.g., receivers. Additionally, the PSI/SI signaling is effectuated by creating new descriptors in existing DVB/DVB-H IPDC notification information tables and/or by creating a new and dedicated notification signaling/network information table. In accordance with other embodiments, the update signaling can be delivered via unicast channels, e.g., short message service (SMS)/multimedia messaging service (MMS) and Open Mobile Alliance (OMA) PUSH.

Various embodiments enable terminals to stay updated with regard to new events and notification messages for a specific default notification message. Additionally, terminals do not have to follow up and tune to the default notification channels along with/in parallel to the consumed service, i.e., stay tuned to two different data bursts simultaneously. Potential inefficiency resulting from continuously tuning into a notification, given the low bitrate nature of the default notification messages, can also be avoided. Moreover, terminals may stay updated with regard to new events, notifications, etc., and the possibility of sacrificing a significant amount of battery and processing power may be avoided.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 illustrates time-slicing effectuated with regard to burst transmissions;

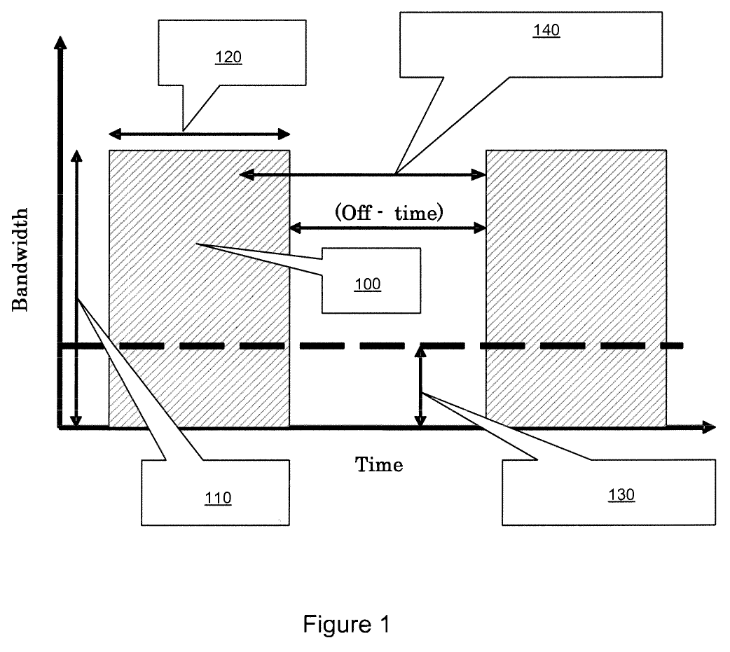

FIG. 2 is an overview diagram of a broadcast and multicast service system within which various embodiments of the present invention may be implemented;

FIG. 3 is a perspective view of a mobile terminal that can be used in the implementation of the present invention;

FIG. 4 is a schematic representation of the terminal circuitry of the mobile terminal of FIG. 3;

FIG. 5 is a diagram of the structure of notification channels in accordance with various embodiments of the present invention;

FIG. 6 is a flow chart illustrating operations performed in accordance with various embodiments of the present invention;

FIG. 7 is an illustration of a network information table in accordance with various embodiments of the present invention;

FIG. 8 is table illustrating a syntax for the IP/MAC notification_info structure in accordance with various embodiments of the present invention; and

FIG. 9 is an INT table in which an edn_descriptor_loop is defined in accordance with various embodiments.

### DETAILED DESCRIPTION OF VARIOUS EMBODIMENTS

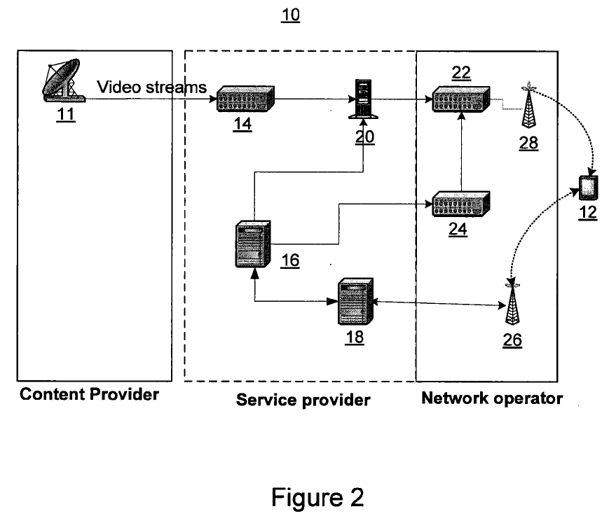

FIG. 2 shows a system 10 illustrating one exemplary architecture of a system for multicast and broadcast services that includes notification functionality. The system 10 can be divided into Content Provider, Service Provider, and Network Operator logical domains. The Content Provider domain, which may include a Captation element 11, can refer to that portion of the system 10 that owns and/or is licensed to sell content and/or content assets. The Content Provider may also in some embodiments be a creator of the content. One purpose of the Content Provider domain is to allow for the acquisition of content by a service provider in the Service Provider domain. It should be noted that the Captation element 11 can refer to any element and/or application capable of capturing desired content.

The Service Provider domain can be utilized to provide an actual service to a subscriber, such as an owner of a mobile terminal 12. It may be noted that different service providers and/or types of service providers can be encompassed by the Service Provider domain, e.g., conventional Internet Service Providers and Content Service Providers. For example, in the context of IP television, the Content Service Provider can acquire and/or license content from one or more content providers and package the content into a service. Therefore, the Service Provider domain can also include an audio/video encoder 14 for encoding content. In addition, the Service Provider domain can include at least some notification services elements, including a notification provider 16, a notification gateway 20, and an application server 18 through which a service provider can provide actual services to the mobile terminal 12.

The Network Operator domain can include a FLUTE file server 24, which in turn can receive notification messages directly from the notification provider 16, and an IP Encapsulator (IPE) 22 which can encapsulate notification messages transmitted through the notification gateway 20. In addition, the IPE 22 can also be utilized to encapsulate notification messages received by the FLUTE file server 24 in IP packets. Whether notification messages are transmitted via the application server 18, the FLUTE file server 24, and/or the IPE 22, connection to the mobile terminal 12 can be effectuated through various types of transmission elements and/or protocols, including but not limited to Digital Video Broadcasting—Handheld/Terresrial (DVB-H/T) transmission, while and Cellular 3G transmission.

In addition, the mobile terminal 12 can be representative of a Consumer domain, where broadcast and multicast services, such as MBMS services and/or content can be consumed. It may be noted that although a single mobile terminal 12 is shown, multiple devices utilizing various communication protocols can be utilized for service consumption, where the multiple devices can be networked and related in various ways. For example, one or more mobile devices can communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A mobile device may communicate using various media including, but not limited to, radio, infrared, laser, cable connection, and the like.

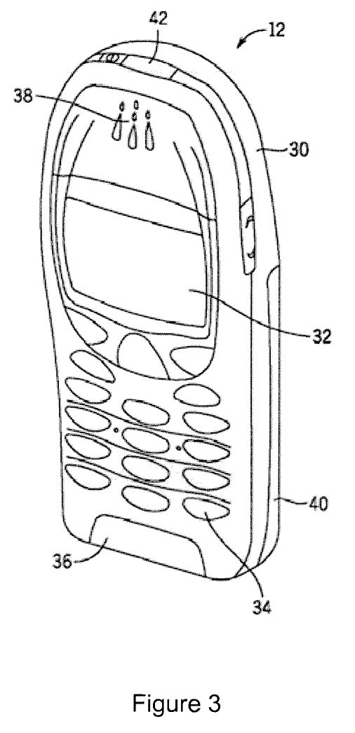

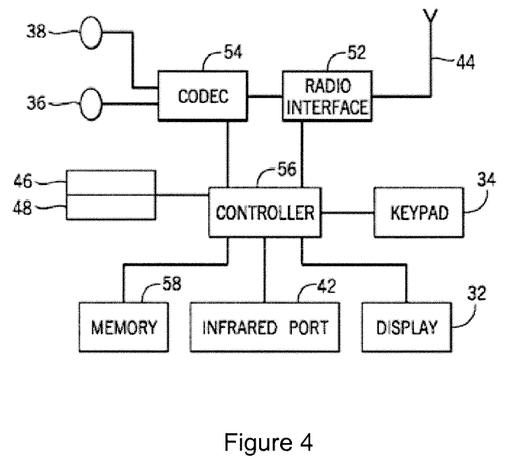

FIGS. 3 and 4 show one exemplary representative of the mobile terminal 12 which can be utilized in conjunction with various embodiments. It should be understood, however, that the present invention is not intended to be limited to one particular type of electronic device. The mobile terminal 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. Individual circuits and elements are all of a type well known in the art, for example in the Nokia range of mobile telephones.

In an IPDC system, such as that shown in FIG. 2, multiple notification channels may be available. Some of these notification channels are default channels, i.e., it can be assumed that a terminal subscribes to such notification channels by default as they carry notification messages of a general nature. Other notification channels can require a specific subscription and interest from the user, as they carry specific information and are either a service in and of themselves or are part of another service. Examples of such default notification channels and default notifications carried thereon which have been identified include, but are not limited to a network default notification (NDN), a platform default notification (PDN), and a electronic service guide (ESG) default notification (EDN). Table 1 describes these default notifications.

TABLE 1

| | Definitions | Cardinality |
|---|---|---|
| NDN | Notification related to the network, e.g., a | 1 per network |
| | broadcast interruption or a change in | |
| | connection parameters. | |
| PDN | Notification related to the IP platform, e.g., a new | 1 per platform |
| | ESG/provider is available. | |
| EDN | Notification related to the ESG/provider, e.g., a | 1 per ESG |
| | new service is available. | provider |

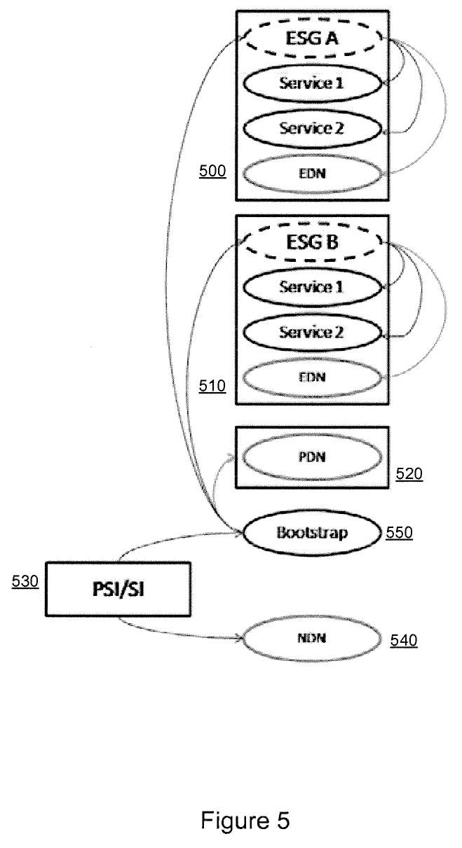

FIG. 5 shows the structure of notification channels in accordance with various embodiments. At 500, a first provider/ESG A is shown where, for example, the format, structure, and transport of the ESG is defined, thus allowing users to select those services, e.g., Service 1 and Service 2, which they are interested in and/or find content stored on a terminal receiver. An EDN is also included at 500. The EDN, as described above, can refer to a new service that is available from the ESG A, where a single EDN exists per ESG. At 510, a second provider/ESG B is shown, along with its own notification, EDN, which can signal, for example, ESG B's Service 1 and/or Service 2. A PDN 520 is also illustrated in FIG. 5. The PDN can, as described above, notify a user of the availability of ESGs/providers, e.g., ESG A and/or ESG B. Additionally, PSI/SI is indicated at 530. PSI/SI can ensure that coherent signaling is utilized within a DVB-H IPDC network. Moreover, such information ensures that the signaling is also interoperable and able to provide roaming and mobility support. Tables of PSI/SI data are implemented, which a terminal receiver can receive in a DVB-H signal. FIG. 5 also shows that a bootstrap process can be effectuated at 550 and a NDN can be originated at 540 from the PSI/SI at 530. The bootstrap process at 550 in turn can be associated with each of ESG A, ESG B, and the PDN at 520.

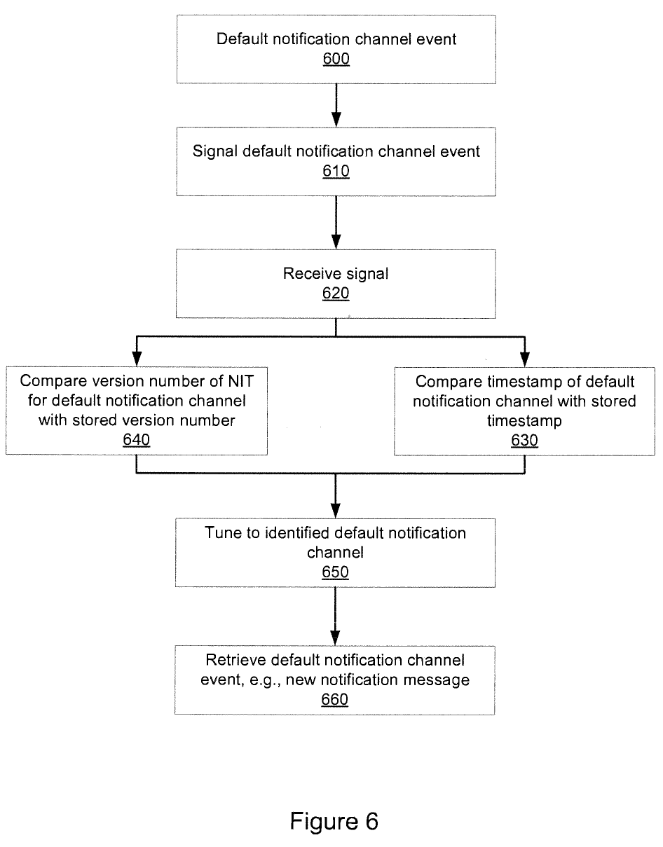

Various embodiments allow for the signaling of changes and updates associated with the default notification channels in IPDC over DVB-H in a non-time sliced way. FIG. 6 shows a flow chart illustrating operations performed by various embodiments. For example, a default notification channel event occurs at 600, where the events of a default notification channel that are signaled can include, but are not limited to, the insertion of a new notification message. At 610, the default notification channel event is signaled, for example, to a receiver terminal from a notification provider, e.g., a notification provider network element, a ESG/provider, a content provider, etc. The signaling can include, but is not limited to: a reference to the default notification channel to which the signaling relates, where the reference can be either implicit or explicit; and a timestamp indicative of the last time the relevant default notification channel has been changed. Alternatively, a version number of a NIT or some other counter can be included in the signaling, where the version number/counter is, for example, increased after each change affecting notification channel. Alternatively still, a combination, for example, of a timestamp and version number/counter can be utilized to determine default notification changes. A receiver can memorize, for example, the last update time for each default notification channel.

Upon receiving a signal indicating that a default notification channel has been updated at 620, the receiver can compare the stored timestamp with the timestamp indicated in the signaling at 630. It should be noted that the comparing can be performed by one or more comparators or applicable logic/circuitry within or in communication with the receiver. If a NIT version number/counter is utilized as described above, the receiver can compare a stored NIT version number/counter to a stored NIT version number/counter at 640, or the comparison can be performed using both a timestamp and a NIT version number/counter. If, for example, the timestamp supersedes the stored timestamp, e.g., is more recent, the receiver tunes in to the default notification channel at 650 to retrieve the new notification message(s) at 660 via an appropriate communication interface.

In addition, the signaling may also indicate a priority of the update, NIT version number/counter, and/or the timestamp of the last high priority notification message in the corresponding default notification session. Other fields associated with the signaling can indicate the type of the new notification message or the action that the terminal needs to perform based on the new notification message.

According to one embodiment, signaling is performed using PSI/SI, where the PSI/SI signaling is not time-sliced and is received by all terminals of one or more associated ESGs/providers (e.g., by default). It should be noted that signaling in PSI/SI can be accomplished using a plurality of techniques. For example, new descriptors can be created within existing DVB/DVB-H IPDC notification information/network information tables and/or a new dedicated table can be created for notification signaling. It should be noted that the timestamp described herein populates a timestamp field that can be, for example, 32 bits in size and corresponds to the most significant bits of the network time protocol (NTP) timestamp in coordinated universal time (UTC). In the case of signaling utilizing existing notification/network tables, where a NIT version number is used instead of a timestamp, the NIT version number can be included in or replace the timestamp in the timestamp field. Alternatively, as described above, a counter can be utilized, where the timestamp field can include or be replaced by a single counter, for example, that is incremented for each change in the corresponding default notification channel.

In accordance with signaling using new descriptors, new descriptors can be created for signaling updates of the default notification channels. According to this aspect of the one embodiment, an implementation for each of the default notification channels is described below.

A NDN can be transmitted/received on a network notification channel that is meant for general network-related messages. It should be noted that notification messages related to a network are to be carried via the same network notification channel (FLUTE carousel) using a given IP address available from the PSI/SI. In other words, a single network can have a single network notification channel, and urgent messages related to the single network can be carried utilizing real-time Transport Protocol (RTP). It should also be noted that since a terminal cannot continuously stay tuned to the IP address of the network notification channel, a particular signaling procedure is required.

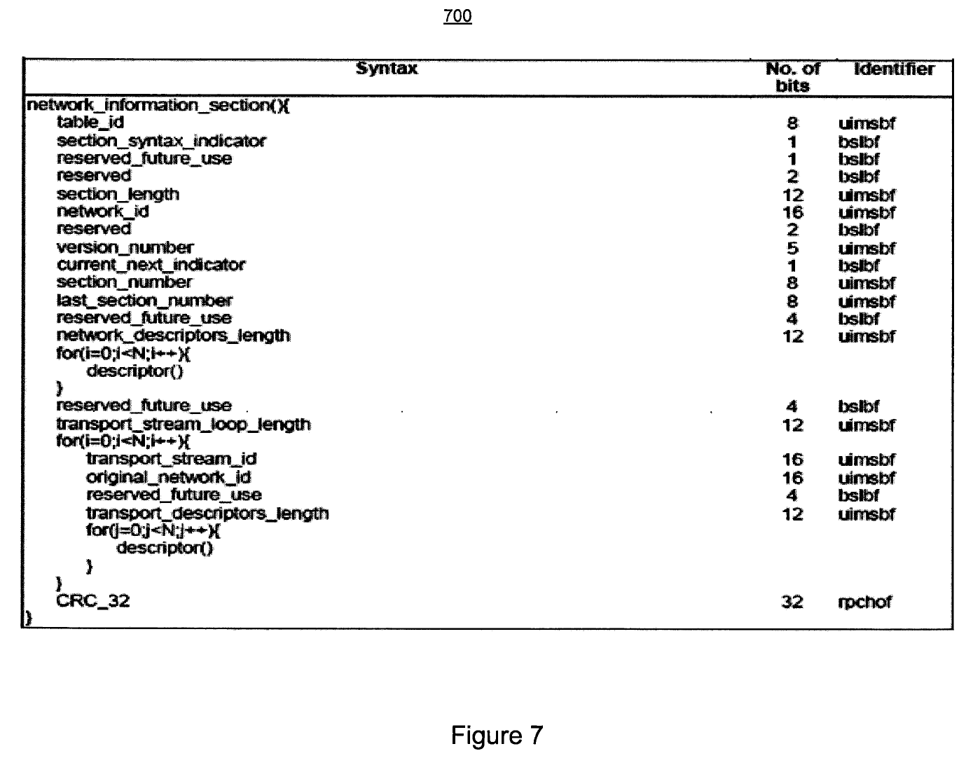

FIG. 7 shows a NIT 700, where information relating to the physical organization of the multiplexes/Transport Streams within a given DVB network is conveyed along with the characteristics of the DVB network itself. The syntax of the network_information_section is given along with the respective number of bits and identifiers related thereto. As shown in FIG. 7, a new descriptor can be defined, where the new descriptor is utilized to signal the presence of a network notification channel that a terminal should tune to. Table 2 below illustrates a possible structure of the new descriptor (e.g., syntax, number of bits required for each portion of the new descriptor, and associated identifiers).

TABLE 2

| Syntax | No. of bits | Identifier |
|---|---|---|
| network_notification_descriptor( ){ | | |
| descriptor_tag | 8 | uimsbf |
| descriptor_length | 8 | uimsbf |
| for(i=n;i<n;i++){ | | |
| ndn_present | 2 | |
| notification_type | 4 | |
| timestamps | 32 | |
| } | | |
| } | | |

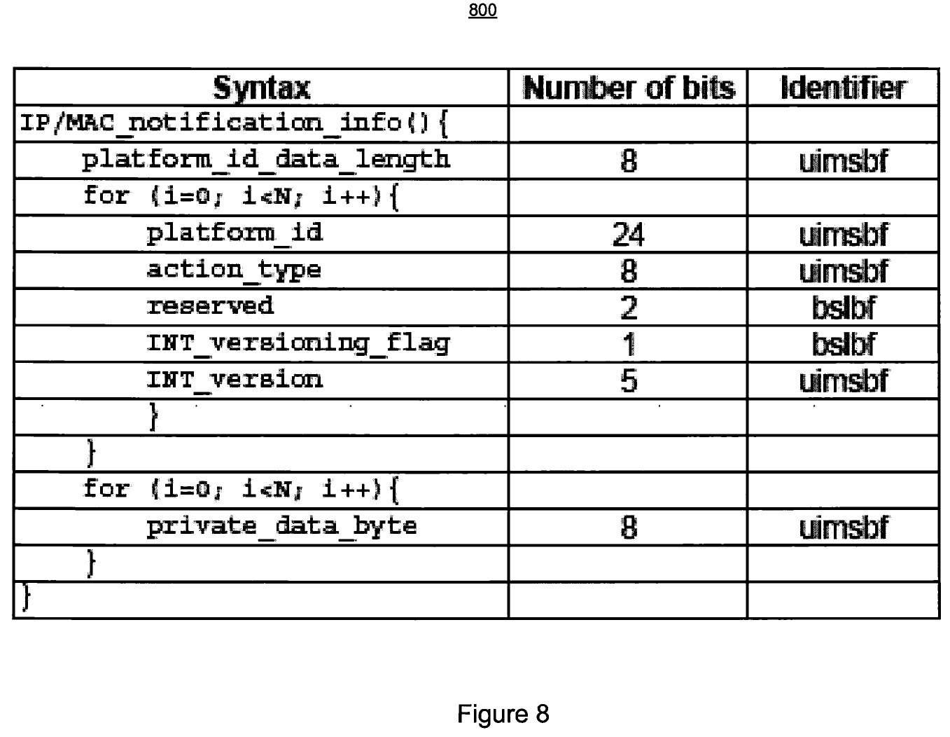

A PDN can be transmitted/received over a platform notification channel which is meant for messages related to the IP platform. Like a NDN, notification messages related to the IP platform are to be carried via the same platform notification channel (FLUTE carrousel) using a given IP address, where one IP platform has one platform notification channel. A fast technique for the receipt of PDN signaling is effectuated with a program map table (PMT) in the data_broadcast_id descriptor by using a private_data byte within the IP/MAC_notification_info loop. FIG. 8 illustrates the structure of the IP/MAC_notification_info 800, where a private data byte can contain the PDN's specific descriptor. Table 3 below shows a structure of the newly created platform_notification_descriptor.

TABLE 3

| Syntax | No. of bits | Identifier |
|---|---|---|
| platform_notification_descriptor( ){ | | |
| descriptor_tag | 8 | uimsbf |
| descriptor_length | 8 | uimsbf |
| for(i=n;i<n;i++){ | | |
| pdn_present | 2 | |
| notification_type | 4 | |
| timestamp | 32 | |
| } | | |
| } | | |

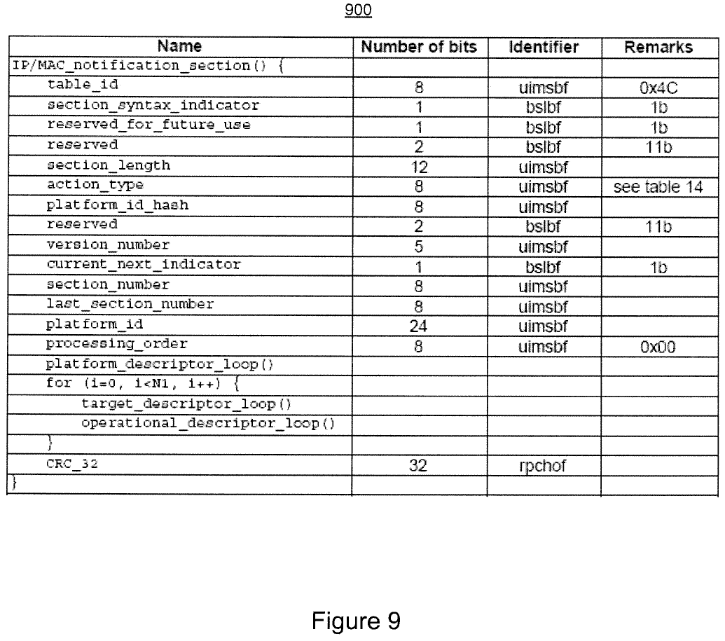

An EDN can be sent and received over a ESG notification channel, where the ESG notification channel is meant for messages related to a given ESG/provider in a given IP platform. Urgent messages related to the ESG/provider can be carried via RTP. It should be noted that a given ESG Provider is assumed to deliver only one ESG at a given time, in a given IP Platform. Several provider notification channels can be present, but one ESG provider is to have only one provider notification channel. In order to signal any update to the EDN, an edn_descriptor_loop is defined within the IP/Media Access Control (MAC) notification table (INT) 900 shown in FIG. 9, and the structure of the edn_descriptor_loop is shown in Table 4 below. It should be noted that the IP/MAC notification table is defined in ETSI standard EN 300 192, “Digital Video Broadcasting (DVB); DVB specification for data broadcasting.”

TABLE 4

| | No. of |
|---|---|
| Syntax | bits |
| edn_descriptor_loop( ) { | |
| reserved | 4 |
| edn_descriptor_loop_length | 12 |
| for(i=0;i<n;i++){ | |
| descriptor( ) | |
| } | |
| } | |

The edn_descriptor_loop contains an information descriptor concerning the updating of the EDN channel. It should be noted again that a ESG/provider is to have one EDN notification channel in a given IP Platform, where the structure of an ESG default notification descriptor is shown in Table 5 below.

TABLE 5

| | No. of |
|---|---|
| Syntax | bits |
| edn_notification_descriptor( ){ | |
| descriptor_tag | 8 |
| descriptor_length | 8 |
| esg_provider_id | |
| timestamp | 32 |
| } | |

As described above, another embodiment can comprise the creation of a dedicated table within the actual PSI/SI structure for notification signaling, e.g., signaling changes within the default notification channels (e.g., NDN, PDN and EDN). Creation of the dedicated table can facilitate the implementation and the updating of actual terminals.

It should be noted that a dedicated table according to such an embodiment is to be sent often, e.g., every 200 ms, so that terminals can know, during the on-time of their DVB-H receivers, whether any of the notification channels are active or have been updated. The actual coding of a Packet Identifier (PID) for DVB is specified in the “Digital Video Broadcasting (DVB)—Specification for Service Information (SI) in DVB Systems”, EN300 468, where PID values ranging from 0x0017 to 0x001B have been reserved for future use. Therefore, it is possible to specify a specific Notification Channel Table (NCT), where dynamic information about notification can be described, such as discovery and signaling of updates in the notification table (for NDN and/or PDN). The structure of the NCT is shown below in Table 6, and the structures of a NDN, a PDN, and a EDN in accordance with this embodiment are shown in Tables 7, 8, and 9, respectively. It should be noted that a change in a default notification channel, for example, can be indicated by using a version number instead of using timestamp information as described above and shown in Tables 7, 8, and 9 below.

TABLE 6

| | No. of |
|---|---|
| Syntax | bits |
| nc_section( ) { | |
| table_id | |
| section_length | |
| last_section_number | |
| network_notification_descriptor_length | |
| for(i=0;i<N;i++) { | |
| Descriptor( ) | |
| } | |
| CRC32 | |
| } | |

TABLE 7

| | No. of |
|---|---|
| Syntax | bits |
| network_notification_descriptor( ){ | |
| descriptor_tag | |
| network_id | |
| action_type | |
| ndn_timestamp | 32 |
| ndn_type | |
| } | |

TABLE 8

| | No. of |
|---|---|
| Syntax | bits |
| platform_notification_{—} descriptor ( ){ | |
| descriptor_tag | |
| platform_id | |
| action_type | |
| pdn_timestamps | 32 |
| pdn_type | |
| } | |

TABLE 9

| | No. of |
|---|---|
| Syntax | bits |
| provider_notification_{—} descriptor ( ){ | |
| descriptor_tag | |
| esg_provider_id | |
| action_type | |
| edn_timestamps | 32 |
| edn_type | |
| } | |

Yet another embodiment comprises an alternative signaling technique for delivering update signaling through the use of unicast channels, such as SMS/MMS, OMA PUSH, or similar technology. That is, the network will push the update signaling to registered users using unicast.

Various embodiments described herein are in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of various embodiments could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of various embodiments have been presented for purposes of illustration and description. It is not intended to be exhaustive or to limit the various embodiments to the precise form disclosed, and modifications and variations are possible in light of the above teachings or may be acquired from practice of the various embodiments. Various embodiments were chosen and described in order to explain the principles discussed herein and its practical application to enable one skilled in the art to utilize various embodiments and with various modifications as are suited to the particular use contemplated.

What is claimed is:

1. A method, comprising:
receiving a signal indicative of a notification channel event, the signal being non-time-sliced and including a reference to a notification channel to which the notification channel event relates and at least one indicator indicating at least one of an updating and changing of the notification channel;
comparing the at least one indicator to at least one stored indicator; and
upon a determination that the at least one indicator supersedes the at least one stored indicator, tuning to the notification channel to process the notification channel event.

2. The method of claim 1, wherein the signal further includes at least one of a priority associated with at least one of the updating and changing of the notification channel and a timestamp associated with a latest high priority notification message.

3. The method of claim 1, wherein the notification channel comprises a default notification channel, and wherein the receiving of the signal is effectuated for all terminals in a digital video broadcasting system.

4. The method of claim 1, wherein the at least one indicator comprises one of a timestamp, a version number, and a counter, and, and wherein each of the timestamp, the version number, and the counter are indicative of a last time, a last version, and a last count, respectively, that the notification channel was at least one of updated and changed.

5. The method of claim 1, wherein the receiving of the signal is performed with program specific information/service information (PSI/SI) signaling.

6. The method of claim 5 further comprising, creating at least one descriptor for at least one existing information table utilized in the PSI/SI signaling.

7. The method of claim 6, wherein the at least one existing information table comprises one of a network information table, a program map table, and an internet protocol notification table.

8. The method of claim 7, wherein the at least one descriptor describes a network default notification, including the at least one indicator, in the network information table.

9. The method of claim 7, wherein the at least one descriptor describes a platform default notification, including the at least one indicator, in the program map table.

10. The method of claim 7, wherein the at least one descriptor describes an electronic service guide default notification, including the at least one indicator, in the internet protocol notification table.

11. The method of claim 5 further comprising, creating at least one dedicated table within a structure for PSI/SI signaling.

12. The method of claim 11, wherein the at least one dedicated table comprises a notification channel table including dynamic information describing at least one of discovery and signaling associated with the notification channel event.

13. The method of claim 11, wherein at least one of a network default notification including the at least one indicator, a platform default notification including the at least one indicator, and an electronic service guide default notification including the at least one indicator is referenced within the notification channel table.

14. The method of claim 1, wherein the receiving of the signal is performed over a unicast channel.

15. A computer program product, embodied on a computer-readable medium, configured to perform the processes of claim 1.

16. An apparatus comprising:
a processor; and
a memory unit communicatively connected to the processor and including:
computer code configured to receive a signal indicative of a notification channel event, the signal being non-time-sliced and including a reference to a notification channel to which the notification channel event relates and at least one indicator indicating at least one of an updating and changing of the notification channel;
computer code configured to compare the at least one indicator to at least one stored indicator; and
computer code configured to, upon a determination that the at least one indicator supersedes the at least one stored indicator, tune to the notification channel to process the notification channel event.

17. The apparatus of claim 16, wherein the notification channel comprises a default notification channel, and wherein the receiving of the signal is effectuated for all terminals in a digital video broadcasting system.

18. The apparatus of claim 16, wherein the receiving of the signal is performed with program specific information/service information (PSI/SI) signaling.

19. The apparatus of claim 18, wherein the memory unit further comprises computer code configured to create at least one descriptor for at least one existing information table utilized in the PSI/SI signaling.

20. The apparatus of claim 19, wherein the at least one existing information table comprises one of a network information table, a program map table, and an internet protocol notification table.

21. The apparatus of claim 20, wherein the at least one descriptor describes a network default notification, including the at least one indicator, in the network information table.

22. The apparatus of claim 20, wherein the at least one descriptor describes a platform default notification, including the at least one indicator, in the program map table.

23. The apparatus of claim 20, wherein the at least one descriptor describes an electronic service guide default notification, including the at least one indicator, in the internet protocol notification table.

24. The apparatus of claim 18, wherein the memory unit further comprises computer code configured to create at least one dedicated table within a structure for PSI/SI signaling.

25. The apparatus of claim 24, wherein the at least one dedicated table comprises a notification channel table including dynamic information describing at least one of discovery and signaling associated with the notification channel event.

26. The apparatus of claim 25, wherein at least one of a network default notification including the at least one indicator, a platform default notification including the at least one indicator, and an electronic service guide default notification including the at least one indicator is referenced within the notification channel table.

27. A system, comprising:
a notification provider configured to transmit a non-time-sliced signal indicative of a notification channel event, the signal including a reference to a notification channel to which the notification channel event relates and at least a first indicator indicating at least one of an updating and changing of the notification channel; and
a receiver configured to:
receive the signal;
compare the at least first indicator to at least a second indicator stored within the receiver; and
upon a determination that the at least first indicator supersedes the at least second indicator, tune to the notification channel to process the notification channel event.

28. The system of claim 27, wherein the notification channel comprises a default notification channel, and wherein the receiving of the signal is effectuated for all terminals in a digital video broadcasting system.

29. The system of claim 27, wherein the receiving of the signal is performed with program specific information/service information (PSI/SI) signaling.

30. The system of claim 29 further comprising, creating at least one descriptor for at least one existing information table utilized in the PSI/SI signaling.

31. The system of claim 30, wherein the at least one existing information table comprises one of a network information table, a program map table, and an internet protocol notification table.

32. The system of claim 27 further comprising, creating at least one dedicated table within a structure for PSI/SI signaling.

33. A method, comprising:
a first means for receiving a signal indicative of a notification channel event, the signal being non-time-sliced and including a reference to a notification channel to which the notification channel event relates and at least one indicator indicating at least one of an updating and changing of the notification channel;
a second means for comparing the at least one indicator to at least one stored indicator; and
a third means for, upon a determination that the at least one indicator supersedes the at least one stored indicator, tuning to the notification channel to process the notification channel event.

34. The method of claim 33, wherein the at least one indicator comprises one of a timestamp, a version number, and a counter, and, and wherein each of the timestamp, the version number, and the counter are indicative of a last time, a last version, and a last count, respectively, that the notification channel was at least one of updated and changed.

35. The method of claim 33, wherein the notification channel comprises a default notification channel, and wherein the receiving of the signal is effectuated for all terminals in a digital video broadcasting system.
